(19) United States
(12) Patent Application Publication
(10) Pub. No.: US 2015/0287528 A1
(43) Pub. Date: Oct. 8, 2015

(54) PROCESS FOR PRODUCING RARE-EARTH MAGNET

(71) Applicants: Kazuaki Haga, Toyota-shi (JP); Noritaka Miyamoto, Toyota-shi (JP); Tetsuya Shoji, Toyota-shi (JP); Daisuke Sakuma, Nagoya-shi (JP)

(72) Inventors: Kazuaki Haga, Toyota-shi (JP); Noritaka Miyamoto, Toyota-shi (JP); Tetsuya Shoji, Toyota-shi (JP); Daisuke Sakuma, Nagoya-shi (JP)

(21) Appl. No.: 14/441,695

(22) PCT Filed: Nov. 13, 2013
(86) PCT No.: PCT/JP2013/080691

§ 371 Date: May 8, 2015

(30) Foreign Application Priority Data
Dec. 25, 2012 (JP) 2012-280867

(51) Int. Cl. H01F 41/00

(52) U.S. Cl. CPC H01F 41/00

(57) ABSTRACT

Provided is a method for manufacturing a rare-earth magnet enabling effective penetrant-diffusion of a melt of modifier alloy powder without generating oxidation reaction or hydroxylation reaction when the modifier alloy powder is used for a better coercive force as well. The method for manufacturing a rare-earth magnet includes: a step of producing a compact S by hot press processing using magnetic powder B including a RE-T-B main phase MP (RE: at least one type of Nd, Pr, and Y) and a grain boundary phase BP around the main phase MP, and performing hot deformation processing to the compact S to produce a rare-earth magnet precursor C; and a step of bringing modifier alloy powder M including a RE-M alloy (M: a metallic element that does not include heavy rare-earth elements) and having an average grain size of 30 μm or more into contact with a surface of the rare-earth magnet precursor C, followed by heating, so that a melt of the modifier alloy powder M is penetrant-diffused into the rare-earth magnet precursor C, to produce the rare-earth magnet RM.

### TECHNICAL FIELD

The present invention relates to a method for manufacturing a rare-earth magnet.

### BACKGROUND ART

Rare-earth magnets containing rare-earth elements such as lanthanoide are called permanent magnets as well, and are used for motors making up a hard disk and a MRI as well as for driving motors for hybrid vehicles, electric vehicles and the like.

Indexes for magnet performance of such rare-earth magnets include remanence (residual flux density) and a coercive force. Meanwhile, as the amount of heat generated at a motor increases because of the trend to more compact motors and higher current density, rare-earth magnets included in the motors also are required to have improved heat resistance, and one of important research challenges in the relating technical field is how to keep magnetic characteristics of a magnet at high temperatures. In the case of a Nd—Fe—B magnet that is one of the rare-earth magnets often used for vehicle driving motors, an attempt has been made to increase the coercive force of such a magnet by making crystal grains finer, by using an alloy having the composition containing more Nd and by adding heavy rare-earth elements such as Dy and Tb having high coercive-force performance, for example.

Rare-earth magnets include typical sintered magnets including crystalline grains (main phase) of about 3 to 5 μm in scale making up the structure and nano-crystalline magnets including finer crystalline grains of about 50 nm to 300 nm in nano-scale.

The following briefly describes one example of the method for manufacturing a rare-earth magnet. For instance, in a typical manufacturing method, Nd—Fe—B molten metal is solidified rapidly to be a melt-spun ribbon (rapidly quenched ribbon), and such a melt-spun ribbon is pulverized to be a desired size to prepare raw-material magnetic powder. Then this magnetic powder is made a compact while performing pressing-forming to the magnetic powder. Hot deformation processing is then performed to this compact to give magnetic anisotropy thereto to prepare a rare-earth magnet precursor (orientational magnet), into which a modifier alloy is penetrant-diffused to improve the coercive force by various methods, thus manufacturing a rare-earth magnet.

Conventionally Dy and an alloy thereof are typically penetrant-diffused as the modifier alloy into the rare-earth magnet precursor, because Dy is used often among heavy rare-earth elements. The amount of deposits of Dy, however, is limited. Then one of important challenges is to develop a Dy-less magnet that includes a reduced amount of Dy while keeping the coercivity performance or a Dy-free magnet to ensure the coercivity performance without containing Dy at all.

Then the present inventors disclosed, in Patent Literature 1, the method of manufacturing a high coercivity rare-earth magnet without using heavy rare-earth elements such as Dy, in which a modifier alloy having a low melting point such as NdCu or NdAl is heated, and a compact subjected to hot-deformation processing is soaked in the melt to let the melt of the modifier alloy penetrate-diffused.

Patent Literature 1 does not mention the form of a modifier alloy to be used, i.e., whether it is in the plate form or in the powder form. The present inventors actually found various problems presenting depending on the form of a modifier alloy.

Firstly, for a modifier alloy in the form of a plate, it is preferable to use a modifier alloy in the form of a plate of 0.3 mm or less in thickness from the viewpoint of the preparation of the melt and its effective diffusion and penetration. A typical method to prepare a thin plate of modifier alloy having such a thickness is rolling. However, a modifier alloy made of NdCu or NdAl easily breaks during rolling, and so it is difficult to prepare such a modifier alloy in the form of a thin plate. Then, another method considered is to cut such a plate from an ingot. However, since the thickness of a modifier alloy plate to be prepared actually has a thickness at the same degree as or thinner in some cases than the thickness of a cutting stone, the material yield will be 50% or lower, meaning rise in the manufacturing cost. In this way, the manufacturing of a thin-plate modifier alloy has problems, such as difficulty in manufacturing and rise in manufacturing cost.

Meanwhile in the case of a powder-form modifier alloy, oxidation reaction or hydroxylation reaction easily takes place. Since such a modifier alloy tends to increase in surface area because of its powder form, such tendency further promotes the oxidation reaction or the hydroxylation reaction. Further a modifier alloy in the powder form has high fluidity, meaning that it is difficult to dispose a modifier alloy of a desired amount at a predetermined region of a compact, and if a modifier alloy of a predetermined amount can be successfully disposed at a predetermined region, the position of the modifier alloy is easily displaced due to an external factor such as vibrations, and so handling is very difficult until the melt of the modifier alloy is penetrant-diffused.

Patent Literature 2 then discloses a method for manufacturing a rare-earth permanent magnet, in which powder made of an alloy having the composition of R¹i-M¹j (R¹ denotes one type or two types or more selected from rare-earth elements including Y and Sc, M¹ denotes one type or two types or more selected from Al, Si, C, P, Ti, V, Cr, Mn, Ni, Cu, Zn, Ga, Ge, Zr, Nb, Mo, Ag, In, Sn, Sb, Hf, Ta, W, Pb, and Bi, i and j denote atomic percentages and satisfy the range of 15<j≦99, and i is the balance) and including 70 volume percentage or more of intermetallic compound phase is disposed on the surface of a sintered body having the composition of Ra-T¹b-Bc (R denotes one type or two types more selected from rare earth elements including Y and Sc, T¹ denotes one type or two types of Fe and Co, a, b, and c denote atomic percentages and satisfy the range of 12≦a≦20, 4.0≦c≦7.0, and b is the balance); the sintered body and the powder are then subjected to heat treatment at a temperature lower than or equal to the sintering temperature of the sintered body in vacuum or in an inert gas, thus diffusing one type or two types or more of elements of R¹ and M¹ included in the powder to the grain boundary part inside of the sintered body and/or in the vicinity of the grain boundary part in the main-phase grains of the sintered body.

Patent Literature 2 further discloses the technique of pulverizing an alloy having the composition of R¹i-M¹ⱼ (R¹, M¹, i and j are as stated above) and including 70 volume percentage or more of intermetallic compound phase into powder of 500 μm or less in average grain size, which is then diffused into organic solvent or water for application on the surface of the sintered body, followed by drying. The resultant in the dry state then undergoes heat treatment.

Such a technique of using powder-form modifier alloy having relatively large dimensions of 500 μm or less in average grain size can solve the problem of easy occurrence of oxidation reaction or hydroxylation reaction, which is the problem when the powder-form modifier alloy is used.

While Patent Literature 2 mentions such an average grain size in the claims, a plurality of embodiments disclosed in the specification describe relatively small grain sizes of the powder-form modifier alloy only, including 7.8 μm and 10 μm or less. That is, it is not clear about the effect from Patent Literature 2 on the powder-form modifier alloy whose average grain size is 8 μm or more. Note here that Patent Literature 2 does not aim to solve the problem of oxidation reaction or hydroxylation reaction during the use of modifier alloy powder, and so does not mention the measure to solve such a problem as the solution to problems.

### CITATION LIST

### Patent Literatures

Patent Literature 1: JP 2010-263172 A

Patent Literature 2: JP 2008-263179 A

### SUMMARY OF INVENTION

### Technical Problem

In view of the problems as stated above, the present invention aims to provide a method for manufacturing a rare-earth magnet by means of modifier alloy powder as a modifier alloy to improve the coercive force, capable of preventing the modifier alloy powder from generating oxidation reaction and hydroxylation reaction or suppressing such reaction, and letting the melt thereof penetrant-diffuse into a rare-earth magnet precursor effectively.

### Solution to Problem

In order to fulfill the object, a method for manufacturing a rare-earth magnet of the present invention includes: a first step of producing a compact by hot press processing using magnetic powder including a RE-T-B main phase (RE: at least one type of Nd, Pr and Y, T: Fe, Fe partially substituted with Co) and a grain boundary phase around the main phase, and performing hot deformation processing to the compact to produce a rare-earth magnet precursor; and a second step of bringing modifier alloy powder into contact with a surface of the rare-earth magnet precursor, the modifier alloy powder including a RE-M alloy (M: a metallic element that does not include heavy rare-earth elements, RE, which may be RE1-RE2, and RE1, RE2: at least one type of Nd, Pr and Y) and having an average grain size of 30 μm or more, followed by heating, so that a melt of the modifier alloy powder is penetrant-diffused into the rare-earth magnet precursor, to produce the rare-earth magnet.

The manufacturing method of the present invention is to reduce the surface area of the modifier alloy powder by bringing the modifier alloy powder of 30 μm or more in average grain size into contact with the rare-earth magnet precursor subjected to hot deformation processing, thus suppressing oxidation reaction and hydroxylation reaction at the modifier alloy powder, and so enabling effective penetrant-diffusion of the modifier alloy powder used into the rare-earth magnet precursor.

The present inventors demonstrated that modifier alloy powder of 30 μmm or more in average grain size can yield a rare-earth magnet having a high coercive force compared with the case including modifier alloy powder having a smaller average grain size.

In addition to the average grain size of the modifier alloy powder that is 30 μm or more, preferably the upper limit of the average grain size is 300 μm or less and desirably 150 μm or less. Such modifier alloy powder having the average grain size of 300 μm or less and desirably 150 μm or less can avoid irregularities in application.

Rare-earth elements making up the crystalline grains (main phase) of the magnetic powder include at least one type of Nd, Pr and Y. In addition, Di (didymium) as an intermediate of Nd and Pr may be used for this.

The metallic element M making up the modifier alloy powder is not a heavy rare-earth element, which may be a “transition metallic element” or a “typical metallic element”, which may include any one type of Cu, Mn, Co, Ni, Zn, Al, Ga, Sn and the like.

Specific examples of the RE-M alloy making up the modifier alloy powder include a Nd—Cu alloy (eutectic point of 520° C.), a Pr—Cu alloy (eutectic point of 480° C.), a Nd—Pr—Cu alloy, a Nd—Al alloy (eutectic point of 640° C.), a Pr—Al alloy (eutectic point of 650° C.), a Nd—Pr—Al alloy, a Nd—Co alloy (eutectic point of 566° C.), a Pr—Co alloy (eutectic point of 540° C.), and a Nd—Pr—Co alloy, and desirably modifier alloy powder having the eutectic point of 580° C. or less is used.

In this way, the present invention allows melting at a low temperature using modifier alloy powder having a low melting point, and so the manufacturing method of the present invention is suitable for, for example, a nano-crystalline magnet (crystalline grain size of about 50 nm to 300 nm) having the problem of coarse crystalline grains when it is placed in a high-temperature atmosphere of about 800° C. or higher.

In a preferable embodiment of the method for manufacturing a rare-earth magnet of the present invention, slurry including mixture of the modifier alloy powder with solvent may be applied to the surface of the rare-earth magnet precursor.

In the slurry of modifier alloy powder, the modifier alloy powder in the form of fine particles settle out in the slurry and tends to concentrate on the surface of the rare-earth precursor on which the slurry is applied, and so the grain-boundary diffusion effect can be enhanced. Further the application of the modifier alloy powder in the form of slurry to the surface of the rare-earth precursor enables disposition of the modifier alloy powder of desired amount at a predetermined region because the slurry has relatively high viscosity. Even if an external factor such as vibrations acts there, the modifier alloy powder (the slurry including that) disposed does not move, and can stay at the disposed region, meaning that the manufacturing method can keep excellent manufacturing efficiency until the melt of the modifier alloy powder is penetrant-diffused.

Preferably the modifier alloy powder has a volume fraction in the slurry that is 50% or more and 90% or less.

The present inventors found that, during the process where slurry is prepared by mixing the modifier alloy powder with organic solvent, for example, which is then applied to the rare-earth magnet precursor, followed by heat treatment to let the melt of the modifier alloy powder penetrant-diffuse, the volume fraction of the modifier alloy powder in the slurry that is 50% or more and 90% or less is preferable, considering the effect to be promoted during this heat treatment, i.e., the effect of modifier alloy powder having a smaller grain size getting caught in modifier alloy powder having a larger grain size. During the heat treatment, the surface of the modifier alloy powder having a larger grain size is less oxidized or hydroxylated, and so such powder is molten faster than the modifier alloy powder having a smaller grain size. That is, the melt of the modifier alloy powder having a larger grain size and being molten faster catches the modifier alloy powder having a smaller grain size and not being molten yet to be molten, and the melt of the substantially entire amount of the modifier alloy powder, for example, can reach the surface of the rare-earth magnet precursor for penetrant-diffusion.

Further since the modifier alloy powder is in the slurry form, the modifier alloy powder having a smaller grain size tends to concentrate on the surface of the rare-earth magnet precursor due to difference in density. On the other hand, the modifier alloy powder having a larger grain size tends to concentrate on the outside of the modifier alloy powder. In this way, the effect of the modifier alloy powder having a smaller grain size getting caught in the modifier alloy powder having a larger grain size can be further enhanced.

### Advantageous Effects of Invention

As can be understood from the above descriptions, according to the manufacturing method of a rare-earth magnet of the present invention, slurry prepared by mixing with solvent is applied at a predetermined region of the rare-earth magnet precursor subjected to hot deformation processing, and the modifier alloy powder used has the average grain size of 30 μm or more, whereby the surface area of the modifier alloy powder can be reduced, and so oxidation reaction or hydroxylation reaction can be suppressed, and the amount of the modifier alloy powder used can be effectively penetrant-diffused into the rare-earth magnet precursor, whereby a rare-earth magnet having a high coercive force can be manufactured.

### BRIEF DESCRIPTION OF DRAWINGS

FIG. 1 schematically illustrates a first step of a method for manufacturing a rare-earth magnet of the present invention in the order of (a), (b) and (c).

In FIG. 2, (a) describes the micro-structure of a compact illustrated in FIG. 1b, and (b) describes the micro-structure of a rare-earth magnet precursor of FIG. 1c.

FIG. 3 illustrates a second step of the method for manufacturing a rare-earth magnet of the present invention in the order of (a) and (b).

FIG. 4 describes the micro-structure of a crystalline structure of the manufactured rare-earth magnet.

FIG. 5 illustrates the experimental result to measure oxygen density of the modifier alloy powder in slurry when their average grain size of the modifier alloy powder in slurry was changed.

FIG. 6 illustrates the experimental result to measure an increase amount in coercive force when their average grain size of the modifier alloy powder in slurry was changed.

FIG. 7 illustrates the experimental result to measure coercive force of the rare-earth magnets with different application thicknesses of slurry on a rare-earth magnet precursor.

FIG. 8 illustrates the experimental result to measure coercive force of the rare-earth magnets with different volume fractions of modifier alloy powder in the slurry.

FIG. 9 illustrates the experimental result to measure the amount of residues of modifier alloy powder left on the surface of rare-earth magnet without being penetrant-diffused while changing volume fractions of modifier alloy powder in the slurry.

### DESCRIPTION OF EMBODIMENTS

The following describes embodiments of a method for manufacturing a rare-earth magnet of the present invention, with reference to the drawings. The illustrated example describes a method for manufacturing a rare-earth magnet in the form of a nano-crystalline magnet, and the method for manufacturing a rare-earth magnet of the present invention is not limited to a nano-crystalline magnet, which of course is applicable to the manufacturing of a sintered magnet including relatively large crystalline grains (e.g., grain size of about 1 μm or more). In the illustrated manufacturing method, modifier alloy powder is in the form of slurry, which is then applied to the surface of a rare-earth magnet precursor, and another method is possible, in which modifier alloy powder is directly brought into contact with the surface of the rare-earth magnet precursor without preparing the slurry-form modifier alloy powder for grain-boundary diffusion.

### Manufacturing Method of Rare-Earth Magnet

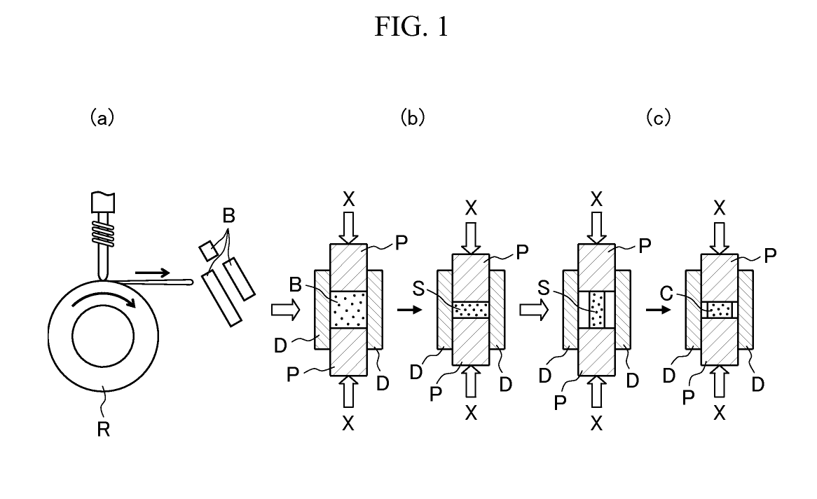

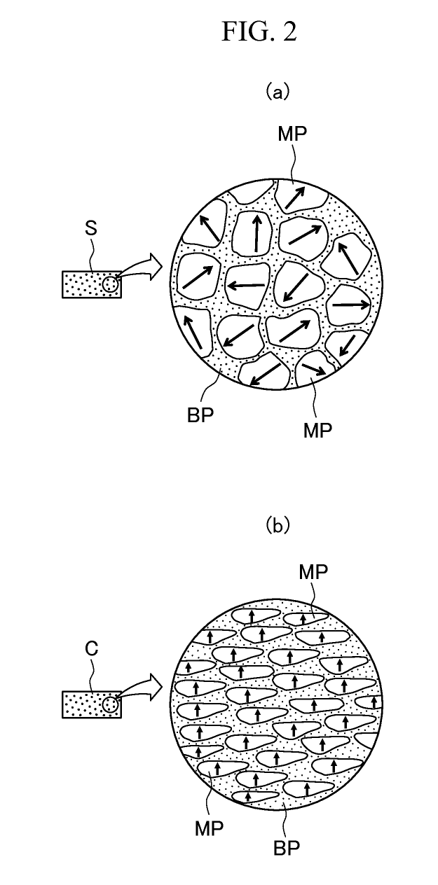

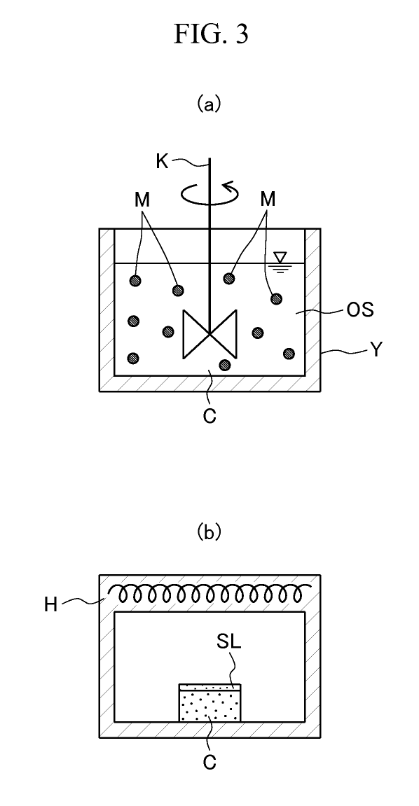

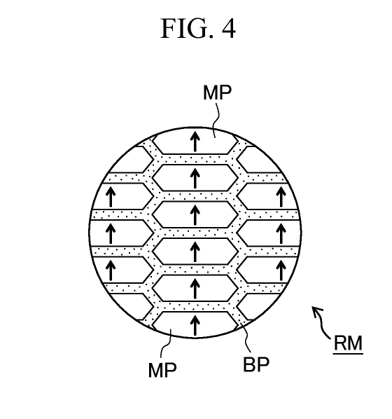

FIGS. 1a, b and c schematically illustrate a first step of a method for manufacturing a rare-earth magnet of the present invention in this order, and FIGS. 3a and b illustrate a second step of the method for manufacturing a rare-earth magnet of the present invention in this order. FIG. 2a describes the micro-structure of a compact illustrated in FIG. 1b, and FIG. 2b describes the micro-structure of a rare-earth magnet precursor of FIG. 1c. Then FIG. 4 describes the micro-structure of a crystalline structure of the manufactured rare-earth magnet.

As illustrated in FIG. 1a, alloy ingot is molten at a high frequency, and a molten composition giving a rare-earth magnet is injected to a copper roll R to manufacture a melt-spun ribbon B (rapidly quenched ribbon) by a melt-spun method using a single roll in an oven (not illustrated) under an Ar gas atmosphere at reduced pressure of 50 kPa or lower, for example. The melt-spun ribbon obtained is then coarse-ground.

A melt-spun ribbon B that is coarse-ground is loaded in a cavity defined by a carbide dice D and a carbide punch P sliding along the hollow of the carbide dice as illustrated in FIG. 1b. Then, ormic-heating is performed thereto while applying pressure with the carbide punch P (X direction) and letting current flow through in the pressuring direction, whereby a compact S is manufactured, including a Nd—Fe—B main phase (having the grain size of about 50 nm to 200 nm) of a nano-crystalline structure and a Nd—X alloy (X: metal element) grain boundary phase around the main phase.

Herein, the Nd—X alloy making up the grain boundary phase is an alloy containing Nd and at least one type of Co, Fe, Ga and the like, which may be any one type of Nd—Co, Nd—Fe, Nd—Ga, Nd—Co—Fe, Nd—Co—Fe—Ga, or the mixture of two types or more of them, and is in a Nd-rich state.

As illustrated in FIG. 2a, the compact S shows an isotropic crystalline structure where the space between the nano-crystalline grains MP (main phase) is filled with the grain boundary phase BP. Then in order to give this compact S anisotropy, the carbide punch P is allowed to come into contact with the end face of the compact S in the longitudinal direction (in FIG. 1B, the horizontal direction corresponds to the longitudinal direction) of the compact S as illustrated in FIG. 1c, and then hot deformation processing is performed while applying pressure with the carbide punch P (X direction), whereby a rare-earth magnet precursor C having a crystalline structure including an anisotropic nano-crystalline grains MP can be manufactured as illustrated in FIG. 2b (this is the first step).

Herein when the degree of processing by the hot deformation processing (the rate of compression) is large, for example, when the rate of compression is about 10% or more, such hot deformation processing can be called heavily hot processing or heavily processing simply.

The rare-earth magnet precursor C in FIG. 2b includes flattened-shaped nano-crystalline grains MP, whose boundary faces that are substantially in parallel to the anisotropic axis are curved or bent, and are not made up of specific faces.

Next in the second step, slurry containing modifier alloy powder to be applied to the rare-earth magnet precursor C is prepared.

As illustrated in FIG. 3a, modifier alloy powder M made of RE-M alloy (M denotes a metallic element that does not include heavy rare-earth elements, RE may be RE1-RE2, where RE1, RE2 denotes at least one type of Nd, Pr and Y) and having the average grain size of 30 μm or more is added to organic solvent OS contained in a vessel Y, followed by mixing with mixing impellers K, thus preparing slurry.

Herein the metallic element M that does not include heavy rare-earth elements may be a transition metallic element or a typical metallic element, where any one type of Cu, Mn, Co, Ni, Zn, Al, Ga, Sn and the like can be used. Among them, a RE-M alloy having a low melting point of 700° C. or lower may be used, for example any one type of a Nd—Cu alloy (eutectic point of 520° C.), a Pr—Cu alloy (eutectic point of 480° C.), a Nd—Pr—Cu alloy, a Nd—Al alloy (eutectic point of 640° C.), a Pr—Al alloy (eutectic point of 650° C.), a Nd—Pr—Al alloy, a Nd—Co alloy (eutectic point of 566° C.), a Pr—Co alloy (eutectic point of 540° C.), and a Nd—Pr—Co alloy may be used, among which a Nd—Cu (eutectic point of 520° C.), a Pr—Cu alloy (eutectic point of 480° C.), a Nd—Co alloy (eutectic point of 566° C.), and a Pr—Co alloy (eutectic point of 540° C.) having a low melting point of 580° or lower are desirably used.

The use of modifier-alloy powder M of 30 μm or more in average grain size can decrease the surface area of the modifier-alloy powder M, and so can suppress oxidation reaction or hydroxylation reaction at the modifier-alloy powder M, meaning that the modifier-alloy powder M used can be penetrant-diffused to the rare-earth magnet precursor effectively.

Preferably the upper limit of the average grain size of the modifier-alloy powder M is 300 μm or less and desirably 150 μm or less. Irregularities in application can be removed through the use of modifier-alloy powder M of 300 μm or less, desirably 150 μm or less in average grain size.

The volume fraction of the modifier-alloy powder M in the slurry is adjusted to be 50% or more and 90% or less. The modifier-alloy powder M and the organic solvent OS are mixed to prepare slurry, which is applied to the rare-earth magnet precursor, followed by heat treatment for penetrant-diffusion of the melt of the modifier-alloy powder M. Considering the effect to be promoted during this heat treatment, i.e., the effect of modifier alloy powder having a smaller grain size getting caught in modifier alloy powder having a larger grain size, the present inventors found that the volume fraction of the modifier-alloy powder M in slurry that is 50% or more and 90% or less is preferable.

Next, as illustrated in FIG. 3b, the thus prepared slurry SL is applied at a predetermined region of the surface of the rare-earth magnet precursor C, followed by heat treatment in a high-temperature oven H, whereby the modifier-alloy powder M in the slurry SL is molten, and the melt of the modifier-alloy powder M is penetrant-diffused via the grain boundary phase of the rare-earth magnet precursor C.

When certain time has passed since the liquid-phase penetration of the melt of the modifier alloy into the grain boundary phase, then the crystalline structure of the rare-earth magnet precursor C in FIG. 2b changes, so that the boundary faces of the crystalline grains MP become clear as illustrated in FIG. 4, and magnetic separation progresses between the crystalline grains MP and MP, whereby a rare-earth magnet RM having improved coercive force can be manufactured (second step). During the step on the way of modifying the structure with the modifier alloy in FIG. 4, boundary faces that are substantially in parallel to the anisotropic axis are not formed (which is not made up of specific faces). However, at the stage where modifying with the modifier alloy progresses sufficiently, then boundary faces (specific faces) that are substantially in parallel to the anisotropic axis are formed, whereby the rare-earth magnet formed includes the crystalline grains MP having a rectangular shape or a shape close to that when being viewed from the direction orthogonal to the anisotropic axis.

According to the illustrated method for manufacturing a rare-earth magnet, the slurry SL is applied to the surface of the rare-earth magnet precursor C, followed by heat treatment. During this heat treatment, the surface of the modifier alloy powder M having a larger grain size is less oxidized or hydroxylated, and so such powder is molten faster than the modifier alloy powder M having a smaller grain size. That is, the melt of the modifier alloy powder M having a larger grain size and being molten faster reaches the surface of the rare-earth magnet precursor C while catching the modifier alloy powder M having a smaller grain size and not being molten yet for penetrant-diffusion. Further since the modifier alloy powder M is in the slurry form, the modifier alloy powder M having a smaller grain size tends to concentrate on the surface of the rare-earth magnet precursor C due to difference in density. On the other hand, the modifier alloy powder M having a larger grain size tends to concentrate on the outside of the modifier alloy powder M. In this way, the effect of the modifier alloy powder M having a smaller grain size getting caught in the modifier alloy powder M having a larger grain size can be further enhanced.

[Experiment to Measure Oxygen Density of Modifier Alloy Powder with Different Average Grain Sizes of Modifier Alloy Powder in Slurry, Experiment to Measure an Increased Amount of Coercive Force of Rare-Earth Magnets and Their Results]

The present inventors conducted the experiment to measure the oxygen density of modifier alloy powder when the average grain size of the modifier alloy powder in slurry was changed, and the experiment to measure an increased amount of coercive force of rare-earth magnets. The following describes a method for manufacturing Example 1 and methods for manufacturing Comparative Examples 1-1 to 1-3.

### EXAMPLE 1

(1) A predetermined amount of rare-earth alloy raw materials (the alloy composition was 29Nd-0.2Pr-4Co-0.9B-0.6Ga-bal. Fe in terms of at %) were mixed, which was then molten in an Ar gas atmosphere, followed by injection of the molten liquid thereof from an orifice to a revolving roll made of Cu with Cr plating applied thereto for quenching, thus preparing magnetic powder for a rare-earth magnet.

(2) Next, this magnetic powder was placed in a carbide mold of 10 mm φ and 40 mm in height, which was sealed with carbide punches vertically.

(3) Next, these carbide mold and carbide punches in the sealed state were set in a chamber, and the pressure was reduced to 10⁻² Pa, while applying load of 400 MPa thereto and heating to 650° C. for pressing. The state after this hot pressing was held for 60 seconds, and then a compact of 14 mm in height was formed.

(4) An oxygen-free copper ring of φ12.5 mm in outer diameter, φ10 mm in inner diameter and 14 mm in height was fitted to this compact, to which hot deformation processing was performed under the conditions of the heating temperature at 750° C., the processing ratio of 75% and the strain rate of 7.0/sec. Herein, BN was applied to the faces of the punches for better lubrication.

(5) From the sample (rare-earth magnet precursor) formed by the hot deformation processing, a sample piece of 4×4×2 mm was cut out, which was for the sample for heat treatment.

(6) Next, modifier alloy powder having the composition of 70Nd30Cu and 90Nd10Cu and having their average grain size of 30, 50, 100, 150, 200, 300, and 500 μm was mixed with organic solvent to prepare slurry. The mixture volume ratio in the slurry was set at the modifier alloy powder: solvent=50:50, and the mixing was performed for 60 seconds until uniformity was achieved.

(7) Next, the slurry was applied to have the thickness of 0.2 μm on the sample of the rare-earth magnet precursor.

(8) Next, this was heat treated at the temperature of 580° C. in the reduced pressure atmosphere or in the inert gas atmosphere in a high-temperature oven for 165 minutes, whereby the sample of rare-earth magnet was prepared.

(9) Magnetic properties were evaluated for the thus prepared rare-earth magnet sample using a pulse magnetometer and a vibrating magnetometer.

### COMPARATIVE EXAMPLE 1-1

At (6) of Example 1, modifier alloy powder of 5 and 10 μm in average grain size was used, and others were similar to Example 1.

### COMPARATIVE EXAMPLE 1-2

At (5) of Example 1, a sample piece of 4×4×0.1 mm was cut out, the oxide film on the surface of which was removed using a file or the like (the thickness of application corresponded to 0.2 mm). At (7) of Example 1, a sample of the rare-earth magnet precursor was placed in a case made of titanium so that slurry was placed at the lower face of the case, and others were similar to Example 1.

### COMPARATIVE EXAMPLE 1-3

At (6) of Example 1, modifier alloy powder of 70Nd30Cu having 5 and 10 μm in average grain size was used, and others were similar to Example 1.

### Verification Results

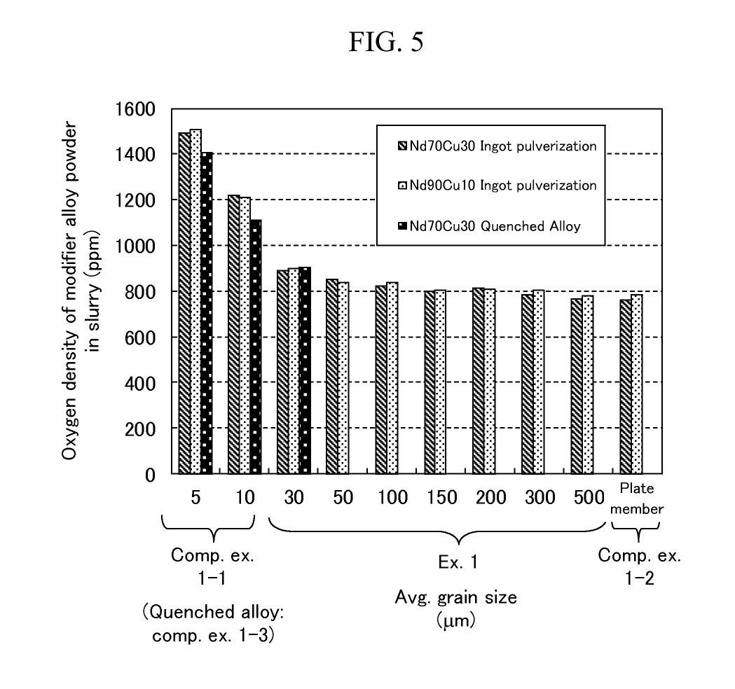

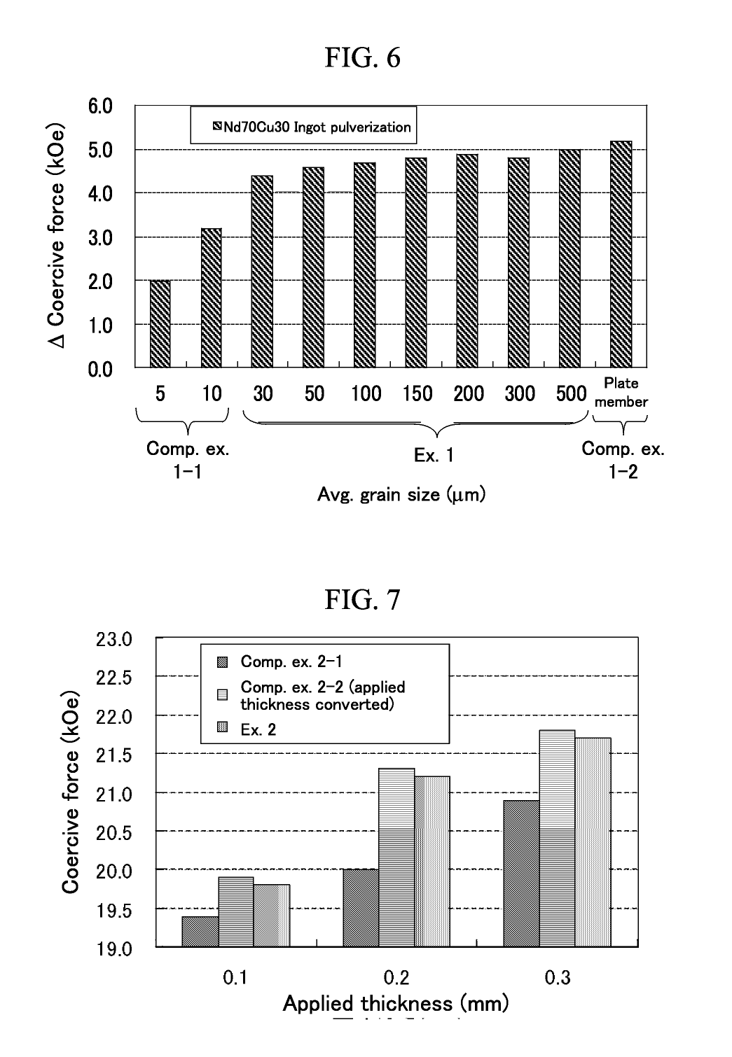

FIG. 5 illustrates the measurement result of oxygen density of the modifier alloy powder in slurry when their average grain size was changed for Example 1 and Comparative Examples 1-1 to 1-3, and FIG. 6 illustrates the measurement result of an increase amount in coercive force. In these drawings, the coercive force is represented in the units of kOe, and when they are to be converted in the SI units (kA/m), the coercive force may be calculated by multiplying the numerical values in the drawings by 79.6.

FIG. 5 shows that the oxygen density in the modifier alloy powder was high for the modifier alloy powder less than 30 μm in average grain size (Comparative Example 1-1). Such tendency conceivably depends on the surface area of the modifier alloy powder.

Meanwhile, it is shown that Example 1 having the average grain size of 30 μm or more had the oxygen density equal to the plate member of Comparative Example 1-2. The modifier alloy powder (Comparative Example 1-3) prepared using quenched alloy had slightly lower oxygen density than other ingot powder, and the effect obtained from the average grain size of 30 μm was low.

FIG. 6 shows that the coercive force decreased with the average grain size of the modifier alloy powder. When the average grain size was 30 μm or more, the coercive force was substantially the same, but when it was less than 30 μm, the coercive force decreased sharply. This results from the correlation with the oxygen density, i.e., higher oxygen density means the generation of oxide of the corresponding amount in the modifier alloy powder, and so the amount of the modifier alloy powder that can contribute to modification is decreased by the amount of the oxide, and so the increased amount in coercive force decreases conceivably.

[Experiment to Measure Coercive Force of Rare-Earth Magnets with Different Application Thicknesses of Slurry on Rare-Earth Magnet Precursor and the Result]

The present inventors conducted the experiment to measure coercive force of a rare-earth magnet that is produced while changing the application thickness of slurry on a rare-earth magnet precursor. The following describes a method for manufacturing Example 2 and methods for manufacturing Comparative Examples 2-1 and 2-2.

### EXAMPLE 2

At (6) of Example 1, modifier alloy powder having the composition of 70Nd30Cu and having the average grain size of 100 μm was mixed with organic solvent to prepare slurry. The mixture volume ratio in the slurry was set at the modifier alloy powder: solvent=50:50. Then at (7) of Example 1, the slurry was applied to have the thicknesses of 0.1, 0.2 and 0.3 μm on the surface of the rare-earth magnet precursors, and others were similar to Example 1. That is, in the following descriptions on Comparative Examples 2-1 and 2-2, Example 2 should be read as Example 1.

### COMPARATIVE EXAMPLE 2-1

At (6) of Example 2, modifier alloy powder of 20 μm in average grain size was used, and others were similar to Example 2.

### COMPARATIVE EXAMPLE 2-2

At (5) of Example 2, sample pieces of 4×4×0.05 mm, 4×4×0.1 mm and 4×4×0.15 mm were cut out, the oxide film on the surface each of which was removed using a file or the like. At (7) of Example 2, a sample of the rare-earth magnet precursor was placed in a case made of titanium so that slurry was placed at the lower face of the case, and others were similar to Example 2.

### Verification Results

FIG. 7 illustrates the measurement result of coercive force of the rare-earth magnets with different application thicknesses of slurry for Example 2 and Comparative Examples 2-1 and 2-2.

For the average grain size of 100 μm, the measurement result of coercive force value was the same as that with a plate member. On the other hand, Comparative Example 2-1 including the modifier-alloy powder of 20 μm in average grain size had a smaller coercive force. Conceivably this resulted from oxidation progressing due to the smaller grain size of the modifier alloy powder, and so the amount of modifier alloy powder, which was to be penetrant-diffused in the rare-earth magnet precursor, was reduced. A slurry residue (oxide of the modifier alloy powder) also was observed, which remained at the upper part of the rare-earth magnet manufactured by heat treatment, and such an observation result also supported the reduced amount of modifier alloy powder, which was to be penetrant-diffused in the rare-earth magnet precursor.

An analysis of such a slurry residue showed that an oxide layer was formed on the surface of the modifier alloy powder. When an oxide layer was present on the surface of modifier alloy powder, the melt of modifier alloy powder has to break this oxide layer and metal therein has to be molten and leaked out for penetrant-diffusion of the melt of modifier-alloy powder into the rare-earth magnet precursor, and such breakage of the oxide layer needs large force. Powder having a larger grain size can have larger power to break this oxide layer. This is because powder having a larger grain size is less affected from oxidation and hydroxylation, and a piece of such powder has larger weight that is required to break the oxide layer. Then the molten modifier alloy powder will catch particles having a smaller grain size that cannot melt due to the smaller grain size to be molten, which then reaches the surface of the rare-earth magnet precursor for penetrant-diffusion and a modification reaction. Such an effect can be understood from FIGS. 5 and 6, showing that whereas the oxide density becomes constant when the average grain size is 50 μm or higher, the coercive force keeps increasing.

In this way, a larger average grain size of the modifier alloy powder leads to effective improvement of coercive force due to two aspects, including that such powder having a larger grain size is less oxidized, and such powder can catch modifier alloy powder including smaller particles that cannot break the oxide layer alone and let the powder melt, and so the total amount of modifier alloy powder used can contribute to the modification of grain boundary phase of the rare-earth magnet. Especially as a method to promote the latter aspect, slurry containing the modifier alloy powder in organic solvent may be applied to the surface of the rare-earth magnet precursor. This is because the modifier alloy powder having a smaller grain size tends to concentrate on the surface side of the rare-earth magnet precursor, and the modifier alloy powder having a larger grain size tends to concentrate on the surface side of the slurry applied on the outside due to density difference resulting from differences in grain size. In this way, the modifier alloy powder having a larger grain size present on the outside melt, which then catches the modifier alloy powder having a smaller grain size present on the inside therein to be molten, and then reaches the surface of the rare-earth magnet precursor. This is good for melting of the modifier alloy powder as a whole and letting the melt penetrant-diffuse.

[Experiment to Measure Coercive Force of Rare-Earth Magnets Produced with Different Volume Fractions of Modifier Alloy Powder in Slurry, Experiment to Measure the Amount of Residue of Modifier Alloy Powder Left on the Surface of Rare-Earth Magnet Without Being Penetrant-Diffused, and Their Results]

The present inventors conducted the experiment to measure coercive force of rare-earth magnets produced with different volume fractions of modifier alloy powder in slurry and the experiment to measure the amount of residue of modifier alloy powder left on the surface of rare-earth magnet without being penetrant-diffused. The following describes a method for manufacturing Example 3 and methods for manufacturing Comparative Examples 3-1 and 3-2.

### EXAMPLE 3

At (6) of Example 1, modifier alloy powder having the composition of 70Nd30Cu and having the average grain size of 100 μm was mixed with organic solvent to prepare slurry. The mixture volume ratio in the slurry was set at the modifier alloy powder: solvent=50:50, 60:40, and 70:30. Others were similar to Example 1. That is, in the following descriptions on Comparative Examples 3-1 and 3-2, Example 3 should be read as Example 1.

### COMPARATIVE EXAMPLE 3-1

At (6) of Example 3, modifier alloy powder of 20 μm in average grain size was used, and others were similar to Example 3.

### COMPARATIVE EXAMPLE 3-2

At (6) of Example 3, the mixture volume ratio in the slurry was set at the modifier alloy powder: solvent=60:40, and others were similar to Example 3.

### Verification Results

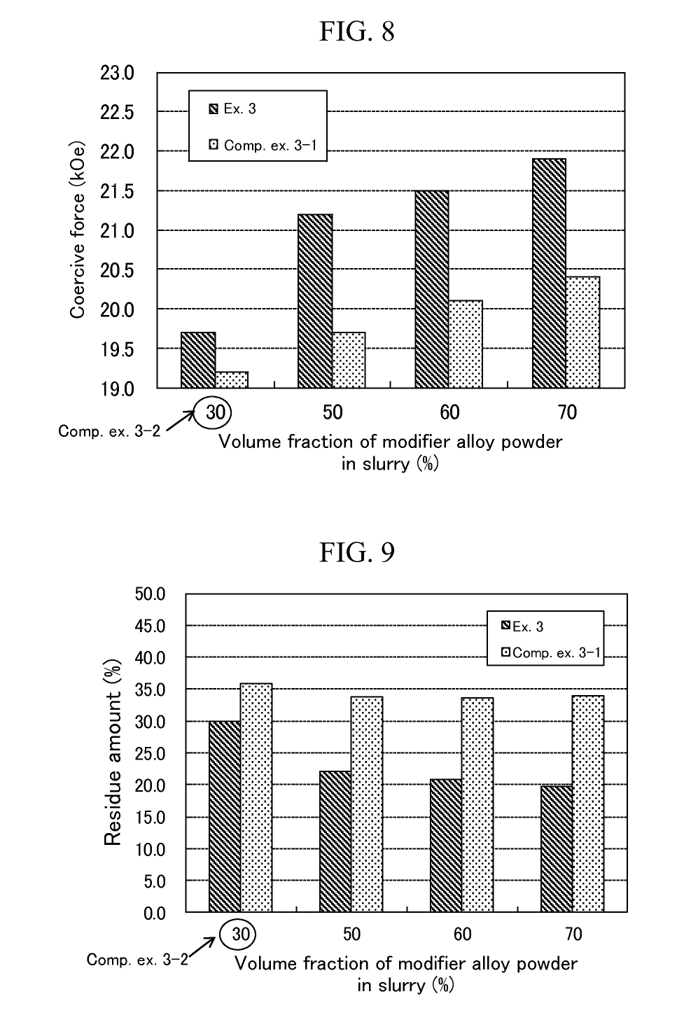

FIG. 8 illustrates the measurement result of coercive force of the rare-earth magnets with different volume fractions of modifier alloy powder in the slurry for Example 3 and Comparative Examples 3-1 and 3-2, and FIG. 9 illustrates the measurement result of the amount of residues.

For the average grain size of 100 μm, the coercive force increased with the volume fraction of the modifier alloy powder in slurry, which reached an inflection point at the volume fraction of 50%. The coercive force sharply decreased for 30% less than that.

On the other hand, in the case of Comparative Example 3-1 (including Comparative Example 3-2 also), the coercive force increased with the volume fraction of the modifier alloy powder in slurry like Example 3. However, the entire volume fractions fell below the values of Example 3.

This is based on the following reason. That is, modifier alloy powder of 10 μm and 20 μm in average grain size is very easy to be oxide, and so an oxide layer is easily formed, resulting in that the amount of modifier alloy powder, which is to be penetrant-diffused into the rare-earth magnet precursor, is reduced. This can lead to a small increasing amount of the coercive force.

On the other hand, Example 3 can have high coercive force because the amount of oxidation of the modifier alloy powder is small, and the effect of smaller particles getting caught in the melt of larger particles leads to the fact that the substantially entire amount of the modifier alloy powder used can contribute to the modification of the grain boundary phase of the rare-earth magnet precursor.

Although the embodiments of the present invention have been described in details with reference to the drawings, the specific configuration is not limited to these embodiments, and the design may be modified without departing from the subject matter of the present invention, which falls within the present invention.

### REFERENCE SIGNS LIST

R Copper roll
B Melt-spun ribbon (rapidly quenched ribbon)
D Carbide dice
P Carbide punch
S Compact
C Rare-earth magnet precursor
H High-temperature oven
M Modifier alloy powder
OS Organic solvent
SL Slurry (Slurry containing modifier alloy powder)
MP Main phase (nano-crystalline grains, crystalline grains)
BP Grain boundary phase
RM Rare-earth magnet

1-5. (canceled)

6. A method for manufacturing a rare-earth magnet, comprising:
a first step of producing a compact by hot press processing using magnetic powder including a RE-T-B main phase (RE: at least one type of Nd, Pr and Y, T: Fe, Fe partially substituted with Co) and a grain boundary phase around the main phase, and performing hot deformation processing to the compact to produce a rare-earth magnet precursor; and
a second step of bringing modifier alloy powder into contact with a surface of the rare-earth magnet precursor, the modifier alloy powder including a RE-M alloy (M: a metallic element that does not include heavy rare-earth elements, RE, which may be RE1-RE2, RE1, RE2: at least one type of Nd, Pr and Y) and having an average grain size of 30 μm or more, followed by heating, so that a melt of the modifier alloy powder is penetrant-diffused into the rare-earth magnet precursor, to produce the rare-earth magnet.

7. The method for manufacturing a rare-earth magnet according to claim 6, wherein slurry including mixture of the modifier alloy powder with solvent is applied to the surface of the rare-earth magnet precursor.

8. The method for manufacturing a rare-earth magnet according to claim 7, wherein the modifier alloy powder has a volume fraction in the slurry that is 50% or more and 90% or less.

9. The method for manufacturing a rare-earth magnet according to claim 6, wherein M in the RE-M alloy includes any one type of Cu, Mn, Co, Ni, Zn, Al, Ga, and Sn.

10. The method for manufacturing a rare-earth magnet according to claim 6, wherein the RE-M alloy includes any one type of a Nd—Cu alloy, a Pr—Cu alloy, a Nd—Pr—Cu alloy, a Nd—Al alloy, a Pr—Al alloy, a Nd—Pr—Al alloy, a Nd—Co alloy, a Pr—Co alloy, and a Nd—Pr—Co alloy.
